(19) United States
(12) Patent Application Publication
(10) Pub. No.: US 2015/0284056 A1
(43) Pub. Date: Oct. 8, 2015

(54) Mooring Light

(71) Applicant: John T. Pyrch, Bridgeport, CT (US)

(72) Inventor: John T. Pyrch, Bridgeport, CT (US)

(21) Appl. No.: 14/677,449

(22) Filed: Apr. 2, 2015

Related U.S. Application Data
(60) Provisional application No. 61/974,776, filed on Apr. 3, 2014.

(51) Int. Cl. B63B 45/00; F21V 23/04; F21V 31/00; B63B 21/00

(52) U.S. Cl. CPC B63B 45/00; B63B 21/00; F21V 23/0435; F21V 23/0464; F21V 31/005; F21V 23/0407; B63B 2021/003; F21Y 2101/02

(57) ABSTRACT

A lighting apparatus for securing atop a pickup stick of a mooring is provided, which illuminates as darkness falls by switching on bright light emitting diodes to light the location of the pickup stick. The apparatus has a lighting section with a casing, surrounding a plurality of light emitting diodes and a circuit. At least one battery is coupled to the plurality of light emitting diodes and the circuit. A dark detecting component is associated with the circuit, and when activated, activates at least one of the light emitting diodes.

### CROSS-REFERENCE TO RELATED APPLICATIONS

This application claims the benefit of U.S. Provisional Application No. 61/974,776 filed Apr. 3, 2014, which is hereby incorporated by reference in its entirety.

### FIELD OF THE INVENTION

The present invention relates to a mooring light configured to secure to the top of the pickup stick of a mooring.

### BACKGROUND OF THE INVENTION

Many individuals using their boat or other watercraft at night have difficulty finding their mooring when they return. The traditional way of finding the mooring at night after a sail is to have someone with a powerful beacon stand on the bow of the boat and shine that beacon throughout the mooring field until you can spot your pickup stick on your mooring. At that point there is communication between the person on the bow of the boat and the person steering the boat in order to navigate to that mooring. However, this activity can be dangerous and cumbersome. It is an object of the present invention to overcome these shortcomings in the art.

### SUMMARY OF THE INVENTION

The present invention relates to a mooring light configured to sit on top of the pickup stick of a mooring that is configured to illuminate as darkness falls by switching on bright light emitting diodes (LEDs) to light the location of the pickup stick.

According to a first aspect of the invention, an apparatus is provided comprising a lighting section. The lighting section includes a casing, which is at least partially clear, surrounding a plurality of light emitting diodes and a circuit. At least one battery is provided with the apparatus, coupled to the plurality of light emitting diodes and the circuit. A dark detecting component is associated with the circuit, and when activated, is configured to activate at least one of the plurality of light emitting diodes. The apparatus further includes a base, through which an opening extends. The opening is dimensioned for receiving a pickup stick of a mooring to mount the apparatus on the pickup stick.

The lighting section of the apparatus according to a first aspect of the invention may comprise a top surface and at least a portion of the top surface that is positioned directly above the dark detecting component is at least partially clear. The lighting section may also have a threaded section configured to removably secure the lighting section to a body section, which comprises the at least one battery and base, and comprising a corresponding threaded section. The body section may also include a water-tight switch to manually turn the circuit and dark detecting component on or off.

Further according to the first aspect of the invention, the body section may comprise a locking member to secure the apparatus to the pickup stick inserted through the opening in the base. The locking member comprises a knob attached to a threaded bolt, and is configured to be inserted into the opening and clamp the pickup stick in place by rotating the locking member through a threaded hole intersecting the opening.

The plurality of light emitting diodes of the apparatus according to the first aspect of the invention may comprise at least a first light emitting diode that emits light having a first color, and at least a second light emitting diode that emits light having a second color different from the first color. A watertight seal is provided around the plurality of light emitting diodes and the circuit.

The dark detecting component of the apparatus according to the first aspect of the invention is configured to prevent the plurality of light emitting diodes from turning on when the apparatus is in sunlight. In one embodiment, the dark detecting component is configured to activate all of the plurality of light emitting diodes, which constantly emit light while activated. In an alternative embodiment, dark detecting component is configured to activate the plurality of light emitting diodes according to a programmed sequence. The programmed sequence can include, for example, each of the plurality of light emitting diodes emitting light simultaneously with a predetermined frequency, or in a Morse code pattern that is repeated while the dark detecting component is activated. If the plurality of light emitting diodes includes at least a first light emitting diode that emits light having a first color, and at least a second light emitting diode that emits light having a second color different from the first color, the programmed sequence includes the plurality of light emitting diodes emitting a flash of light in a predetermined order to create a particular sequence of colored light flashes that is repeated while the dark detecting component is activated.

The apparatus according to the first aspect of the invention may include a remote control to control the apparatus from a distance.

According to a second aspect of the invention, a mooring is provided comprising a pickup stick, and a lighting apparatus secured to the pickup stick. The apparatus includes lighting section with a casing, which is at least partially clear, surrounding a plurality of light emitting diodes and a circuit. At least one battery is provided with the apparatus, coupled to the plurality of light emitting diodes and the circuit. A dark detecting component is associated with the circuit, and when activated, is configured to activate at least one of the plurality of light emitting diodes. The apparatus further includes a base, through which an opening extends. The opening is dimensioned for receiving a pickup stick of the mooring to mount the apparatus on the pickup stick.

### BRIEF DESCRIPTION OF THE DRAWINGS

FIG. 1 shows an embodiment comprising a mooring light of the present invention affixed to a mooring pickup stick;

FIG. 2 shows an embodiment of a mooring light according to the present invention;

FIG. 3 shows an embodiment of a lit mooring light according to the present invention;

FIG. 4 shows the top surface of an embodiment of a mooring light according to the present invention;

FIG. 5 shows an overhead view of the light emitting diodes and circuit of a mooring light according to the present invention; and

FIG. 6 shows the base surface of a mooring light according to the present invention.

### DETAILED DESCRIPTION OF THE DRAWINGS

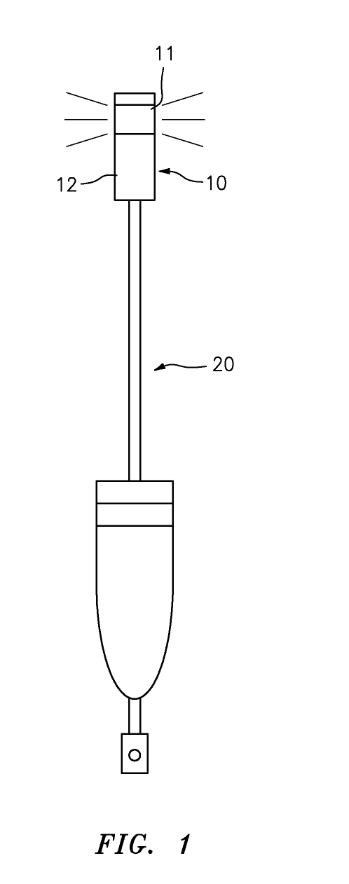

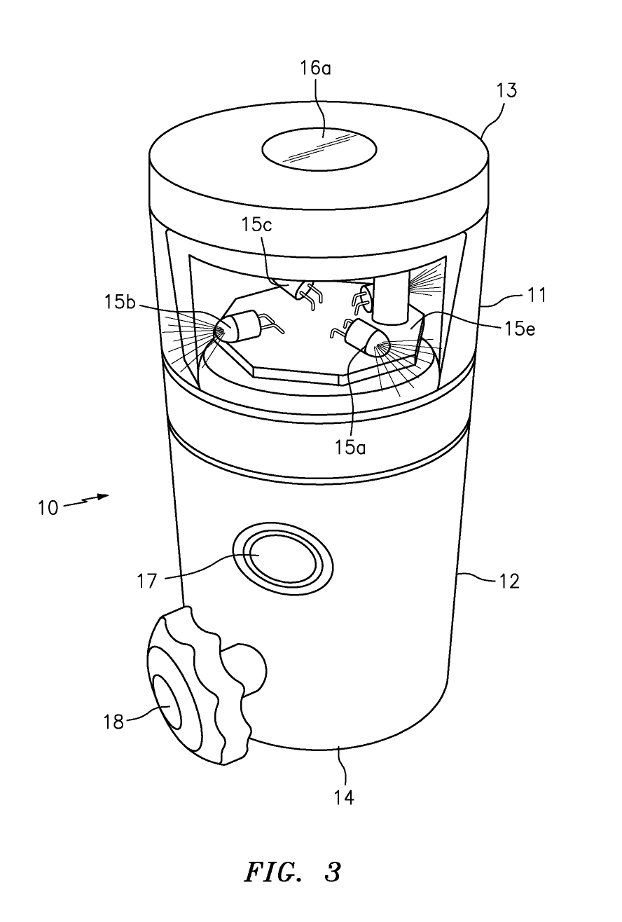

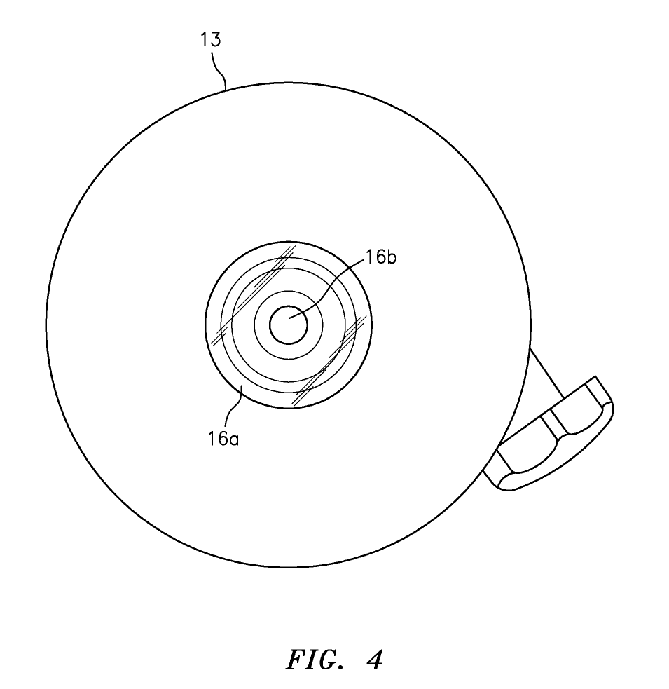

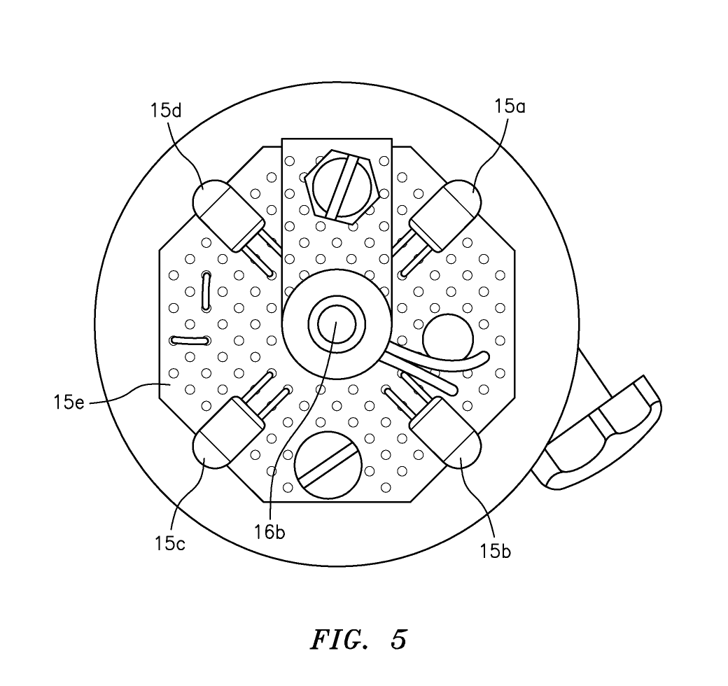

The present invention is described in further detail below with reference made to FIGS. 1-6.

According to an embodiment of the present invention, an apparatus or mooring light 10 is provided that enables an individual to locate their particular mooring at night or during low visibility conditions. The mooring light 10 of the present invention is configured to be secured to a pickup stick 20, as shown in FIG. 1.

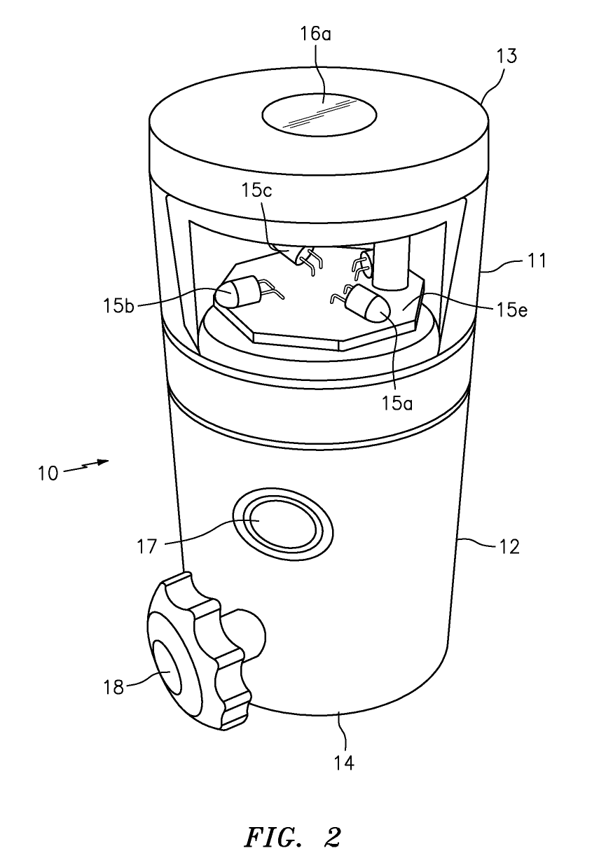

According to an exemplary embodiment, which is shown in FIGS. 2-6, the mooring light 10 comprises a lighting section 11 and a body section 12, which are positioned between a top surface 13 and a base surface 14. In the embodiment shown in the Figures, the mooring light 10 is substantially cylindrical with a diameter of approximately 1.5 inches and a height of approximately 3 inches. However, the present invention is not limited to this particular shape and size configuration. In a preferred embodiment, the body section 12 of the mooring light 10 is made from a lightweight material, such as aluminum. However, the mooring light 10 can be made from alternative materials that would be suitable for use as a lighting structure affixed to a pickup stick 20 attached to a mooring.

The lighting section 11 includes a clear or semi-clear encasing around a plurality of light emitting diodes 15a, 15b, 15c and 15d and an associated circuit 15e. The casing can be formed from a clear or semi-clear material, such as glass or plastic.

In one embodiment, the light emitting diodes 15a, 15b, 15c and 15d each emit a red colored light that is visible from 250 to 300 feet away, so that it can be easily seen by a person approaching the light from a boat at a distance. In alternative embodiments of the invention, the number and color of light emitting diodes can vary. For example, it is possible that only two light emitting diodes are included in the lighting section, or that one or more of the plurality of light emitting diodes emit a first color light (e.g., red), and one or more of the plurality of light emitting diodes emit one or more other colors (e.g., blue, green, white).

The circuit 15e can be any dark-detecting light emitting circuit known in the art. As can be seen in FIGS. 2-5, a dark detecting component 16b of the circuit 15e is positioned beneath a clear window 16a in the top surface 13 of the mooring light 10. When the dark detecting component 16b is activated, such as when the mooring light 10 is outside at night, the light emitting diodes 15a, 15b, 15c and 15d are switched on. When the dark detecting component 16b is not activated, such as when the mooring light 10 is receiving sunlight, the light emitting diodes 15a, 15b, 15c and 15d remain off. Therefore, the present invention allows for the reduced use of power by preventing the light emitting diodes 15a, 15b, 15c and 15d from being used during conditions where there is a sufficient amount of light to locate the pickup stick 20 without the use of the mooring light 10.

The mooring light 10 also comprises a body section 12. The body section 12 may comprise a water-tight switch 17 configured to turn the circuit 15e on or off. When the switch 17 is turned “off”, the dark detecting component 16b is not activated and the light emitting diodes 15a, 15b, 15c and 15d are not turned on at night or during low-visibility conditions. When the switch 17 is turned “on”, the circuit 15e is operable in the manner discussed above. The mooring light 10 can therefore save power by being switched off during periods where the user does not anticipate the mooring light 10 will be used.

The body section 12 is also configured to store the battery or batteries (not shown) that are used to provide electric power to the circuit 15e. In one embodiment, the mooring light 10 comprises two AA batteries; however, the invention is not limited to a particular size or number of battery. In an alternative embodiment, the mooring light 10 may comprise and be powered by a lightweight, rechargeable battery. Such a battery could be rechargeable by the solar energy to which the apparatus 10 is exposed to during daylight.

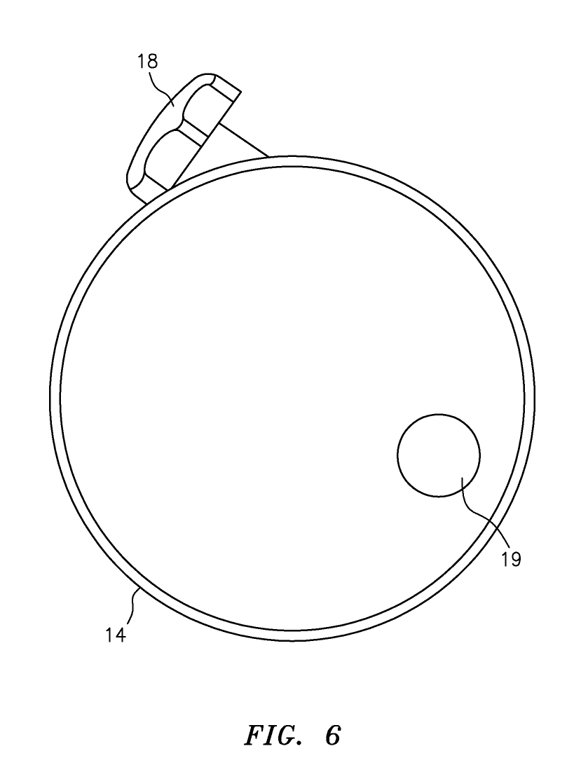

The body section 12 also comprises a locking member 18, which comprises a rotatable knob affixed to an elongated threaded member. As shown in FIG. 6, the base of the mooring light 10 comprises an opening 19. The opening 19 is configured to receive the pickup stick 20. The locking member 18 extends through the body section 12 perpendicularly to the opening 19, and by rotating the knob of the locking member 18, the elongated threaded member is inserted further into the body section 12 in to the opening 19 until it clamps the pickup stick 20 into place within opening 19. This secures the mooring light 10 to the pickup stick 20. By reversing this process, the user can remove the mooring light 10 from the pickup stick 20 during non-use, or to replace or maintain any components of the mooring light 10. The present invention is not limited to this means for securing the mooring light 10 to the pickup stick 20, but in alternative embodiments of the invention, alternative means for securing may be used.

The lighting section 11 is detachably secured to the body section 12 of the mooring light 10. In the embodiment shown in the Figures, the base of the lighting section 11 and the top of the body section 12 comprise corresponding threaded regions which allow the lighting section 11 and the casing of the lighting section 11 to be screwed onto or off the body section 12. As a result, the mooring light 10 maintains a watertight seal around the light emitting diodes 15a, 15b, 15c and 15d, when the mooring light 10 is in use, but also allows for an easy to use mechanism for replacing the light emitting diodes 15a, 15b, 15c and 15d if necessary.

The present invention may comprise additional features not already described herein. For example, the mooring light 10 may comprise a programmable component that permits the owner or manufacturer to program a flashing sequence for the light emitting diodes 15a, 15b, 15c, 15d that would permit the owner to distinguish his or her mooring light 10 from the mooring light 10 of another. For example, the light emitting diodes can be programmed to flash with a particular frequency or in a particular pattern similar to Morse code in a repeated sequence. Alternatively, the plurality of light emitting diodes 15a, 15b, 15c, 15d can be programmed to flash in a particular order in a repeated sequence. Where the plurality of light emitting diodes 15a, 15b, 15c, 15d emit different colored lights, the order that the lights flash would present a recognizable and distinguishable color sequence or pattern that the user could identify as representing their mooring light 10. A control panel can be included on the device or be provided separately from and connected in a wired or wireless manner to the device to allow the user to set a program for the light emitting diodes 15a, 15b, 15c, 15d.

The invention may also comprise a fob configured with a remote button to turn on the mooring light 10 from a distance, in lieu of or in addition to the switch 17 and/or dark detecting component 16b or a remote system to set flashing sequences for the light emitting diodes 15a, 15b, 15c, 15d and to turn on and off multiple units.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed:

1. An apparatus comprising:
a lighting section comprising a casing, which is at least partially clear, surrounding a plurality of light emitting diodes and a circuit;
at least one battery coupled to the plurality of light emitting diodes and the circuit;
a dark detecting component associated with the circuit, which when activated, is configured to activate at least one of the plurality of light emitting diodes; and
a base, through which an opening extends, wherein the opening is dimensioned for receiving a pickup stick of a mooring to mount the apparatus on the pickup stick.

2. The apparatus according to claim 1, wherein the lighting section comprises a top surface and at least a portion of the top surface that is positioned directly above the dark detecting component is at least partially clear.

3. The apparatus according to claim 1, wherein the plurality of light emitting diodes comprises at least a first light emitting diode that emits light having a first color, and at least a second light emitting diode that emits light having a second color different from the first color.

4. The apparatus according to claim 1, wherein the lighting section comprises a threaded section, configured to removably secure the lighting section to a body section of the apparatus comprising the at least one battery and base, and comprising a corresponding threaded section.

5. The apparatus of claim 4, wherein the body section further comprises a water-tight switch to manually turn the circuit and dark detecting component on or off.

6. The apparatus according to claim 4, wherein the body section further comprising a locking member to secure the apparatus to the pickup stick inserted through the opening.

7. The apparatus according to claim 6, wherein the locking member comprises a knob attached to a threaded bolt.

8. The apparatus according to claim 7, wherein the locking member is configured to be inserted into the opening and clamp the pickup stick in place by rotating the locking member through a threaded hole intersecting the opening.

9. The apparatus according to claim 1, wherein a watertight seal is provided around the plurality of light emitting diodes and the circuit.

10. The apparatus according to claim 1, wherein the dark detecting component is configured to prevent the plurality of light emitting diodes from turning on when the apparatus is in sunlight.

11. The apparatus according to claim 1, wherein the dark detecting component is configured to activate all of the plurality of light emitting diodes, which constantly emit light while activated.

12. The apparatus according to claim 1, wherein the dark detecting component is configured to activate the plurality of light emitting diodes according to a programmed sequence.

13. The apparatus according to claim 12, wherein the programmed sequence includes each of the plurality of light emitting diodes emitting light simultaneously with a predetermined frequency.

14. The apparatus according to claim 12, wherein the programmed sequence includes the plurality of light emitting diodes emitting light simultaneously in a Morse code pattern that is repeated while the dark detecting component is activated.

15. The apparatus according to claim 12, wherein the plurality of light emitting diodes comprises at least a first light emitting diode that emits light having a first color, and at least a second light emitting diode that emits light having a second color different from the first color.

16. The apparatus according to claim 15, wherein the programmed sequence includes the plurality of light emitting diodes emitting a flash of light in a predetermined order to create a particular sequence of colored light flashes that is repeated while the dark detecting component is activated.

17. The apparatus according to claim 1, further comprising a remote control to control the apparatus from a distance.

18. A mooring comprising:
a pickup stick, and
a lighting apparatus secured to the pickup stick comprising:
a lighting section comprising a casing, which is at least partially clear, surrounding a plurality of light emitting diodes and a circuit;
at least one battery coupled to the plurality of light emitting diodes and the circuit;
a dark detecting component associated with the circuit, which when activated, is configured to activate at least one of the plurality of light emitting diodes; and
a base, through which an opening extends, wherein the opening is dimensioned for receiving a pickup stick of a mooring to mount the apparatus on the pickup stick.
